(19) United States
(12) Patent Application Publication
(10) Pub. No.: US 2012/0285036 A1
(43) Pub. Date: Nov. 15, 2012

(54) ELECTRODE DRYER AND METHOD FOR DRYING ELECTRODE

(76) Inventors: Takahiro MATSUYAMA, Osaka (JP); Naoto NISHIMURA, Osaka (JP)

(21) Appl. No.: 13/464,004

(22) Filed: May 4, 2012

(30) Foreign Application Priority Data
May 12, 2011 (JP) 2011-106853

(51) Int. Cl. F26B 13/30

(52) U.S. Cl. 34/406; 34/92

(57) ABSTRACT

An electrode dryer includes a drying furnace; and
a conveyance member for longitudinally conveying a band-like electrode base material coated with a coating material from an entrance to an exit of the drying furnace, the drying furnace including an air-permeable mounting member for horizontally supporting the electrode base material to be conveyed in the drying furnace; and a suction member for sucking the electrode base material through the air-permeable mounting member.

### CROSS-REFERENCE TO RELATED APPLICATION

This application is related to Japanese patent application No. 2011-106853 filed on May 12, 2011 whose priority is claimed under 35 USC §119, the disclosure of which is incorporated by reference in its entirety.

### BACKGROUND OF THE INVENTION

1. Field of the Invention

The present invention relates to an electrode dryer that is used in the production of electrodes and a method for drying an electrode.

2. Description of the Related Art

As electrodes of lithium-ion batteries and the like, those obtained by forming an electrode composite material on a surface of an electrode base material are used. The electrodes are produced by dispersing or dissolving a positive-electrode or negative-electrode active material and a binder in a wetting agent to prepare an electrode slurry, and applying and drying the electrode slurry on an electrode base material made of a metal foil using a coating and drying apparatus to form a positive-electrode or negative-electrode active material layer.

FIG. 6A is a plan view of a conventional coating and drying apparatus 600 seen from above. FIG. 6B is a side view of the coating and drying apparatus 600. First, an electrode base material 601 is sent out of an electrode base material supply roll and conveyed along a conveyance path to reach a coater 602. The coater 602 applies an electrode slurry 603 as a coating material on the electrode base material 601 being conveyed. Next, the electrode base material 601 coated is further conveyed to reach a drying furnace 605 via a support roller 604 at an entrance side of the drying furnace 605 to be dried at a high temperature while being conveyed. After completion of the coating, the electrode base material is rewound around an electrode rewind roll via a support roller 604 at an exit side of the drying furnace 605.

To deal with capacity increase and cost reduction of recent energy devices, electrodes have been required to be thicker. Generally, most drying furnaces are long, having a total length of more than 10 meters to several tens meters. In the drying step, however, the electrode base material 601 is supported only by the support rollers 604 at the opposite sides and not secured at and around the central part when in the drying furnace. The electrode base material 601 made of a thin metal foil would therefore hang down due to the weight of the electrode slurry as shown by a broken line in FIG. 6B. As a result, the electrode would greatly warp during the drying or the electrode base material 601 would be swung by hot air to result in an uneven electrode.

FIG. 7 is a schematic view of a dryer 700 disclosed in Japanese Unexamined Patent Application Publication No. HEI 11(1999)-138084 (published on May 25, 1999). Japanese Unexamined Patent Application Publication No. HEI 11(1999)-138084 discloses a technique in which clamps 703 arranged at the same intervals as uncoated portions 705 in an electrode base material 702 coated at intervals with an electrode composite material 701 as an electrode slurry move together with metallic belts 704 at the same speed as the speed for conveying the electrode base material 702 while clamping and securing the uncoated portions 705 at both upper and lower surfaces.

FIG. 8 is a schematic view of a device for preventing base material shaking 800 in a vertical drying furnace disclosed in Japanese Unexamined Patent Application Publication No. 2000-88459 (published on Mar. 31, 2000). In this device, roller chains 802 are disposed at opposite sides in the width direction of an electrode sheet 801 coated with an electrode composite material on both the surfaces, and the roller chains 802 circle around in synchronization with conveyance of the electrode sheet 801. The roller chains 802 are fitted with clips 803 on the whole circumferences and move with the conveyance of the electrode sheet 801 with the clips 803 clipping and securing uncoated side edges 804 of the electrode sheet 801.

However, according to the method disclosed in Japanese Unexamined Patent Application Publication No. HEI 11(1999)-138084 in which the clamps clamp and secure the electrode base material at the uncoated portions, the clamps will not be able to clamp or secure the electrode base material when the electrode composite material is applied not at intervals but on the whole surface to provide no uncoated portions. According to the method disclosed in Japanese Unexamined Patent Application Publication No. 2000-88459 in which the clips provided to the roller chains clip the electrode sheet at opposite side edges in the width direction, the electrode sheet is not secured around the central part, and therefore the central part may hang down in the width or length direction of the electrode sheet due to the weight of an electrode active material layer applied thereon particularly when the electrode active material layer is thick. If dried while thus hanging down, the electrode sheet may warp or have uneven coating. Furthermore, both the methods disclosed in the documents cannot exclude the possibility that the electrode base material (electrode sheet) made of a thin metal foil is wrinkled due to some reasons such as warm air blown in the drying step.

### SUMMARY OF THE INVENTION

In view of the above-described problems, the present invention has been achieved to provide an electrode dryer and a method for drying an electrode that can prevent hanging and wrinkles of an electrode base material, and reduce uneven coating during drying to steadily provide even electrodes.

According to an aspect of the present invention, there is provided an electrode dryer comprising: a drying furnace; and a conveyance member for longitudinally conveying a band-like electrode base material coated with a coating material from an entrance to an exit of the drying furnace, the drying furnace comprising: an air-permeable mounting member for horizontally supporting the electrode base material being conveyed in the drying furnace; and a suction member for sucking the electrode base material being conveyed through the mounting member.

The mounting member may have a width equal to or larger than a width of the electrode base material.

The mounting member may have a plane surface for holding the electrode base material.

The mounting member may be composed of a plurality of rollers.

The mounting member may be an endless member traveling with conveyance of the electrode base material.

The suction may be reduced or stopped in the vicinity of the exit of the drying furnace.

According to another aspect of the present invention, there is provided a method for drying an electrode, comprising the step of: drying a band-like electrode base material coated with a coating material while longitudinally conveying the electrode base material from an entrance to an exit of a drying furnace, the drying step comprising the steps of: mounting the electrode base material being conveyed on an air-permeable mounting member; and sucking the electrode base material through the mounting member.

The present invention can prevent hanging and wrinkles of an electrode base material, and swing of the electrode base material due to hot air blown during drying to reduce uneven coating, allowing stable production of even electrodes.

### BRIEF DESCRIPTION OF THE DRAWINGS

FIG. 1A is a side view of an electrode dryer according Embodiment 1;

FIG. 1B is a view taken along a line A-A in FIG. 1A;

FIG. 1C is an explanatory diagram illustrating a suction mechanism of the electrode dryer illustrated in FIG. 1A;

FIG. 2 is a schematic configuration diagram of the electrode dryer according to Embodiment 1;

FIG. 3 is a schematic configuration diagram of an electrode dryer according to Embodiment 2;

FIG. 4 is a diagram illustrating a shape of a metallic roller;

FIG. 5 is a schematic configuration diagram of an electrode dryer according to Embodiment 3;

FIG. 6A is a schematic configuration diagram of a conventional and general coating and drying apparatus;

FIG. 6B is a schematic configuration diagram of the conventional and general coating and drying apparatus;

FIG. 7 is a schematic cross sectional view of a conventional dryer; and

FIG. 8 is a schematic view of a device for preventing base material shaking of a conventional vertical drying furnace.

### DESCRIPTION OF THE PREFERRED EMBODIMENTS

Hereinafter, embodiments of the present invention will be described based on the drawings.

### Embodiment 1

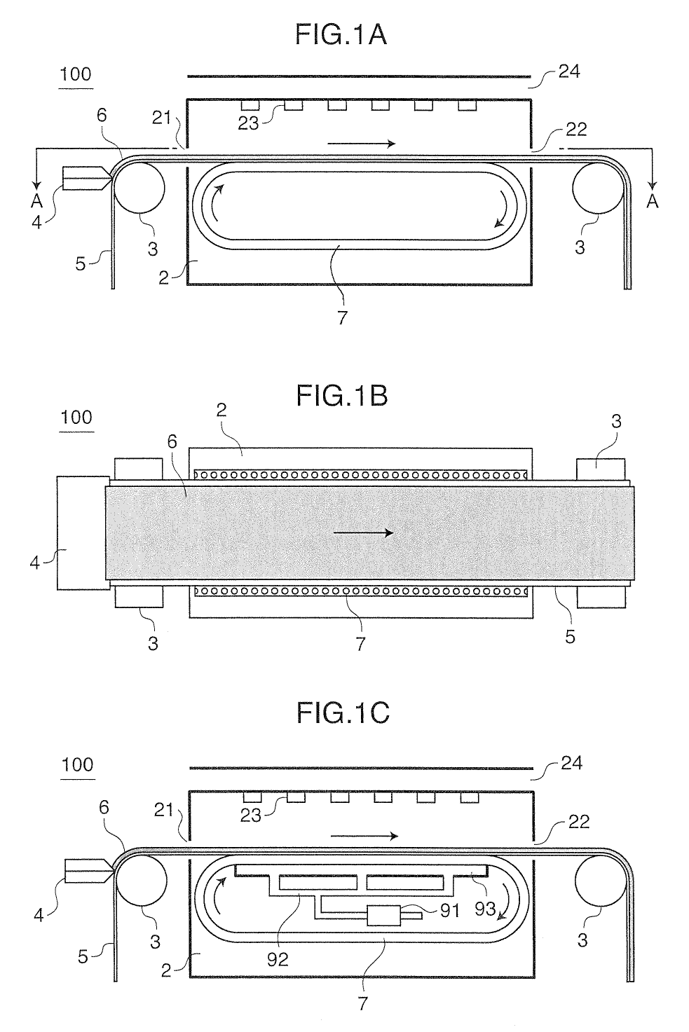

FIGS. 1A and 1B are schematic configuration diagrams of an electrode dryer 100 according to Embodiment 1. Specifically, FIG. 1A is a side view of the electrode dryer 100, and FIG. 1B is a view taken along a line A-A in FIG. 1A. The electrode dryer 100 mainly includes a drying furnace 2, support rollers 3, a coater 4 and a mounting member 7. The electrode dryer 100 is an apparatus that dries a band-like electrode base material 5 coated with an electrode slurry 6 as a coating material by the coater 4 while conveying the electrode base material 5.

The drying furnace 2 is in a box shape having openings at predetermined positions in opposite sides. The electrode base material 5 coated with the electrode slurry 6 on one surface is introduced to the drying furnace 2 through an entrance 21 provided in one side of the drying furnace 2 (left side in FIG. 1A), goes through a predetermined drying process in the drying furnace 2, and then conveyed out of the drying furnace 2 through an exit 22 provided in the other side of the drying furnace 2. In the drying furnace 2, for example, a hot air duct 24 for taking in hot air from an external source is provided so as to extend along a conveyance direction of the electrode base material 5, and a plurality of hot air nozzles 23 are provided to the hot air duct 24 at a side facing the electrode base material 5 along the direction in which the hot air duct 24 extends. Hot air is blown from the hot air nozzles 23 to the electrode base material 5 to dry the electrode slurry 6 on the electrode base material 5. The electrode base material 5 is dried on a mounting member 7 provided in the drying furnace 2, which will be described later in detail.

The support rollers 3 are driven by a drive mechanism, not shown, to support the electrode base material 5 when the band-like electrode base material 5 coated with the electrode slurry 6 on one surface is conveyed in a predetermined direction. The support rollers 3 are disposed at front and back sides of the conveyance direction having the drying furnace 2 therebetween and rotated with the conveyance of the electrode base material. Alternatively, the support rollers 3 themselves may have a driving function. In this configuration, the respective support rollers 3 at the front and back sides of the conveyance direction are rotated about the same axial direction for the conveyance. When the electrode base material 5 is conveyed left to right in FIG. IA, for example, the respective support rollers 3 are rotated clockwise (right-handedly) for the conveyance.

The coater 4 is provided so as to face one surface of the electrode base material 5 and applies the electrode slurry 6 on the surface of the electrode base material 5 while the electrode base material 5 is being conveyed, supported by the support rollers 3. The coater 4 has a slit die, for example, and extrudes the electrode slurry 6 from a slit formed in the die to coat the electrode base material 5. The coater 4 is not limited to a die coater, and usable examples thereof include roll coaters, reverse roll coaters, engraved-roll coaters and rod coaters. An appropriate coater may be used according to the conditions such as the material and the thickness of the electrode slurry to apply.

The electrode base material 5 is made of a metal foil. Usable examples thereof include aluminum, copper, nickel, iron and stainless steel. Specifically, an aluminum foil may be used for a positive-electrode current collector, and a copper foil may be used for a negative-electrode current collector, for example. The thickness of the metal foil is not particularly limited, and may be 15 to 20 μm in the case of aluminum or approximately 10 μm in the case of copper, for example.

The electrode slurry 6 includes a positive-electrode slurry to be used for forming a positive electrode and a negative-electrode slurry to be used for forming a negative electrode. The positive-electrode slurry is prepared by adding a solvent to a positive-electrode active material, a conductive agent and a binder, for example, and has a specified viscosity. In the case of a lithium-ion secondary battery, for example, a lithium-containing compound can be used for the positive-electrode active material. Preferable examples thereof include complex oxides, sulfides and selenides of lithium and titanium, molybdenum, copper, niobium, vanadium, manganese, chromium, nickel, iron, cobalt or phosphorus. Specific examples thereof include LiMnO₂, LiMn₂O₄, LiNiO₂, LiCoO₂, LiCrO₂, LiFeO₂, LiVO₂ and LiMPO₄, wherein M represents at least one element selected from Co, Ni, Mn and Fe. These compounds may be used independently, or two or more kinds may be used in combination.

The conductive agent is not particularly limited as long as it is a material having electron conductivity which is generally used as a battery material and which does not chemically change in a lithium secondary battery composed therefrom. Examples thereof include graphites such as natural graphites (flake graphite, flaky graphite, earthy graphite, and the like) and artificial graphites; carbon blacks such as acetylene black, ketjen black, channel black, furnace black, lamp black and thermal black; conductive fibers such as vapor grown carbon fiber (VGCF), carbon fiber and metallic fiber; metallic powders such as copper, nickel, aluminum and silver; conductive whiskers such as zinc oxide and potassium titanate; conductive metal oxides such as titanium oxide; and organic conductive materials such as polyphenylene derivatives. These conductive agents may be used independently, or two or more kinds may be used in combination. Of these conductive agents, acetylene black, VGCF, a combination of a graphite and acetylene black are particularly preferable.

As the binder, one kind of polysaccharides, thermoplastic resins and polymers having rubber elasticity that are generally used as battery materials or a mixture of two or more kinds may be used. Preferable examples thereof include starch, polyvinyl alcohol, carboxymethylcellulose, hydroxypropylcellulose, regenerated cellulose, diacetyl cellulose, polyvinyl chloride, polyvinylpyrrolidone, polytetrafluoroethylene, polyvinylidene fluoride, polyethylene, polypropylene, ethylene-propylene-diene polymer (EPDM), sulfonated EPDM, styrene-butadiene rubber, polybutadiene, fluorine-containing rubber and polyethylene oxide.

The solvent is, for example, NMP (N-methylpyrrolidone). Alternatively, toluene, methyl ethyl ketone or water may be used as the solvent.

The negative-electrode slurry is prepared by adding a solvent to a negative-electrode active material, a conductive agent and a binder, for example, and has a specified viscosity. In the case of a lithium-ion secondary battery, for example, at least one kind of graphite-based substances such as natural graphites, artificial graphites and high crystallinity graphites; amorphous carbon-based substances; and metal oxides such as Nb₂O₅ and LiTiO₄ may be used independently, or two or more kinds may be used in combination for the negative-electrode active material. The conductive agent, the binder and the solvent may be the same as those used in the positive-electrode slurry.

The electrode slurry 6 applied on the electrode base material 5 is heated and dried in the drying furnace 2 to form a positive electrode or a negative electrode. The solvent contained in the electrode slurry 6 is removed from the electrode slurry 6 through volatilization.

The mounting member 7 is provided in the drying furnace 2, and the electrode base material 5 coated with the electrode slurry 6 is dried while on the mounting member 7. The mounting member 7 is made of a metallic belt, for example, and connected to a rotary drive mechanism, not shown. This rotary drive mechanism drives the mounting member 7 in synchronization with the speed at which the electrode base material 5 is conveyed.

The metallic belt is supported on a plurality of driven rollers, not shown. Preferably, therefore, the metallic belt has a plane surface and a width equal to or larger than the width of the electrode base material 5 in a direction perpendicular to the conveyance direction of the electrode base material 5. Held on a plane having a width equal to or larger than the width of the electrode base material 5, the electrode base material 5 is prevented from hanging down during the drying and from having uneven coating as a result. Furthermore, the mounting member 7 has an air-permeable porous structure, made of a ceramic material, stainless steel, carbon, PTFE, for example, and holds the electrode base material 5 on a plane using negative pressure applied by a suction mechanism by means of a vacuum pump or the like.

FIG. 1C illustrates a specific example of the suction mechanism. In the configuration illustrated in this drawing, the electrode base material 5 is held on a plane by means of a suction mechanism composed of a chamber 93 caused to have negative pressure due to pressure reduction by a vacuum pump 91 through a pipe 92. In this specific example, the thin electrode base material 5 can be more stable as being held not only by the plane but also by the suction to be further prevented from swinging during the drying, and it is therefore possible to reduce uneven coating due to hanging and wrinkles, and obtain a highly even electrode.

According to the above-described steps, the electrode slurry 6 is applied on the electrode base material 5 and dried to produce an electrode. When the electrode slurry 6 is to be applied on both the surfaces of the electrode base material 5, coating and drying on one surface is completed first, and then coating and drying is performed again on the other surface according to the same steps.

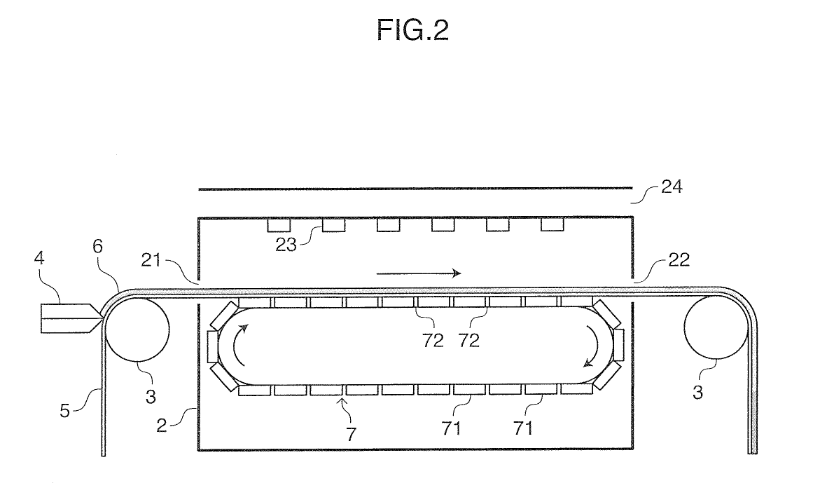

In FIG. 1, the mounting member 7 is an endless member without the use of a coupling member. Alternatively, the mounting member 7 may have a structure in which a plurality of metallic components 71 are connected as illustrated in FIG. 2, for example. In this case, the metallic components 71 may be connected so as to have some gaps 72 therebetween at their connections, so that the suction can be performed through the gaps 72 even if the metallic components 71 themselves do not include suction holes.

The suction mechanism may perform suction evenly on the whole area where the electrode base material 5 contacts with the surface of the mounting member 7 or may be configured to adjust the suction strength depending on the part in such a manner that, for example, the suction strength is increased in the vicinity of the entrance 21 of the drying furnace 2, whereas the suction strength is reduced in the vicinity of the exit 22 of the drying furnace 2. Alternatively, the suction mechanism may be able to control the timing of the suction depending on the direction, strength and the like of the hot air from the hot air nozzles 23 in the drying furnace 2. Alternatively, the suction mechanism may stop the suction in the vicinity of the exit 22 of the drying furnace 2.

While the metallic components 71 are used in FIG. 2, the material of the components does not necessarily have to be metallic and may be any as long as it can withstand the temperature in the drying furnace 2, and it can form a shape allowing the electrode base material 5 to be planarly held thereon.

### Embodiment 2

Next, Embodiment 2 will be described. Embodiment 2 has the same general configuration as Embodiment 1 except for the shape of the mounting member.

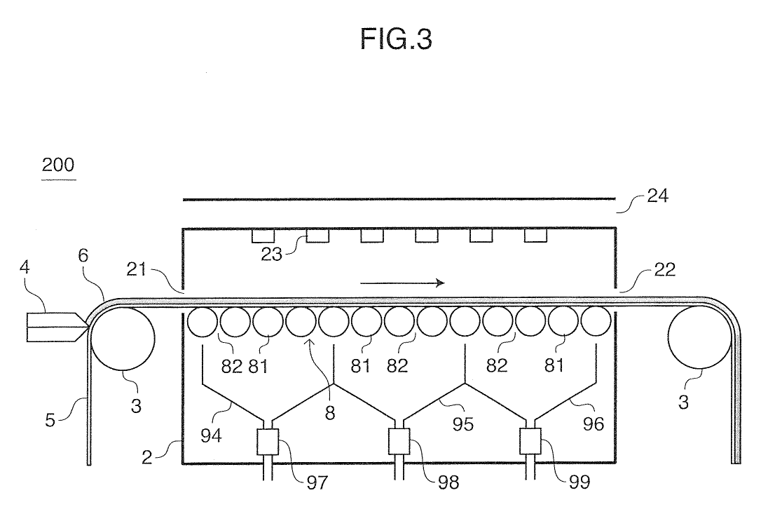

FIG. 3 is a schematic configuration diagram of an electrode dryer 200 according to Embodiment 2 seen from a side. A mounting member 8 is composed of a plurality of metallic rollers 81 arranged planarly with their rotation axes oriented in the same direction, for example. The number of the metallic rollers 81 can be determined appropriately according to the conditions of the electrode base material 5 being conveyed.

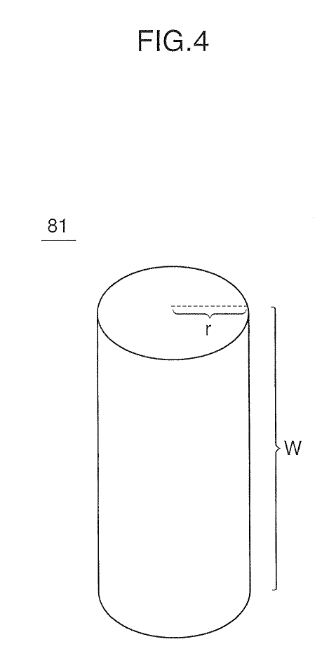

FIG. 4 is a diagram illustrating a shape of each metallic roller 81. The radius r of the metallic rollers 81 can be determined in view of the fact that a too large radius results in a large gap between the electrode base material 5 and the metallic rollers 81 connected in series to fail in stable holding of the electrode base material 5, though it depends on the conditions of the electrode base material 5 being conveyed. Preferably, the metallic rollers 81 have a width w equal to or larger than the width of the electrode base material 5. The width equal to or larger than the width of the electrode base material 5 allows stable holding of the electrode base material 5. The electrode slurry 6 on the electrode base material 5 conveyed into the drying furnace 2 by the support rollers 3 is dried on the plurality of metallic rollers 81. The respective metallic rollers 81 are connected to a rotary drive mechanism, not shown. This rotary drive mechanism drives the metallic rollers 8 in synchronization with the speed at which the electrode base material 5 is conveyed. As illustrated in FIG. 3, the mounting member 8 has an air-permeable structure in which the electrode base material 5 is sucked through gaps 82 between the metallic rollers 81. Specifically, the electrode base material 5 is sucked toward the metallic rollers 81 to be held on a plane by means of vacuum pumps 97, 98 and 99 connected to suction funnels 94, 95 and 96, respectively, provided below the metallic rollers 81. The suctions of the vacuum pumps 97, 98 and 99 are independently controllable. For example, the suction of the vacuum pump 99 closest to the exit 22 may be reduced, or only the vacuum pump 99 may be stopped.

Since the plurality of metallic rollers 81 are used for the mounting member 8 as described above, the electrode base material 5 can be held on a plane to be stable during the drying, and therefore uneven coating due to hanging and wrinkles can be reduced.

While the metallic rollers 81 are used in the present embodiment, the material of the rollers does not necessarily have to be metallic and may be any as long as it can withstand the temperature in the drying furnace 2, and it can form a shape allowing the electrode base material 5 to be planarly held thereon.

### Embodiment 3

Next, Embodiment 3 will be described. Embodiment 3 has the same general configuration as Embodiment 1 and Embodiment 2 except for the shape of the mounting member.

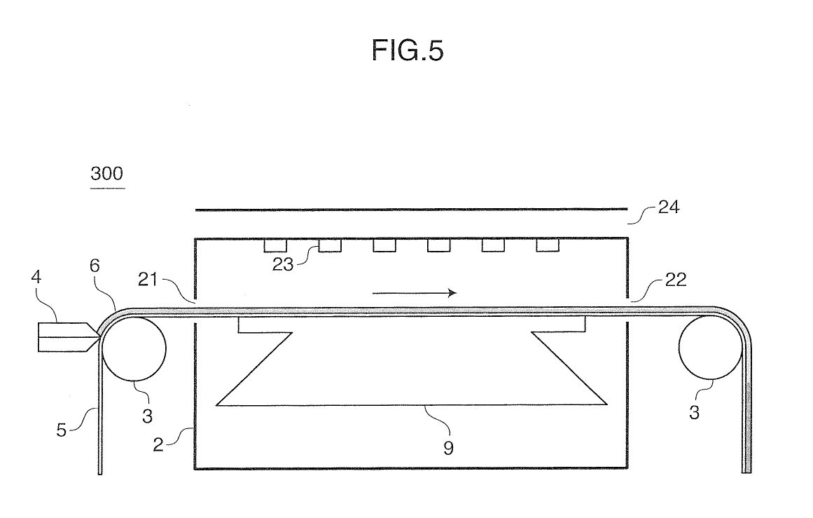

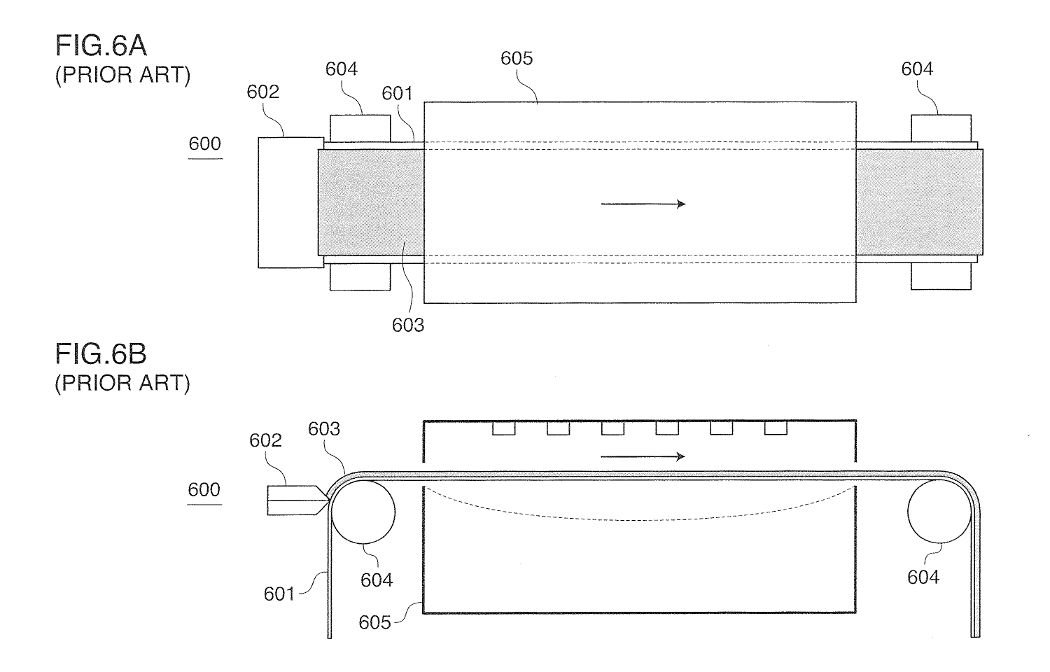

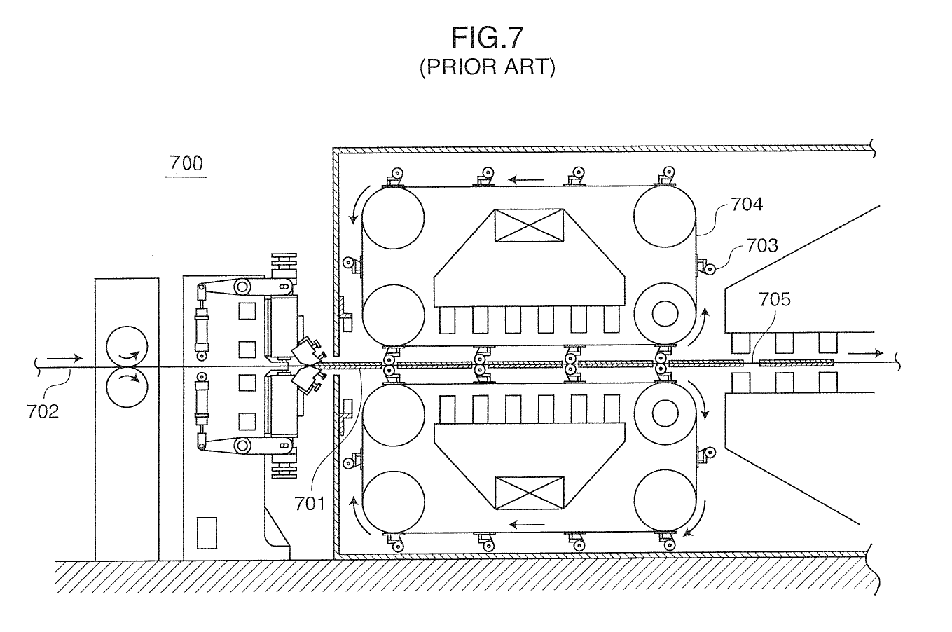

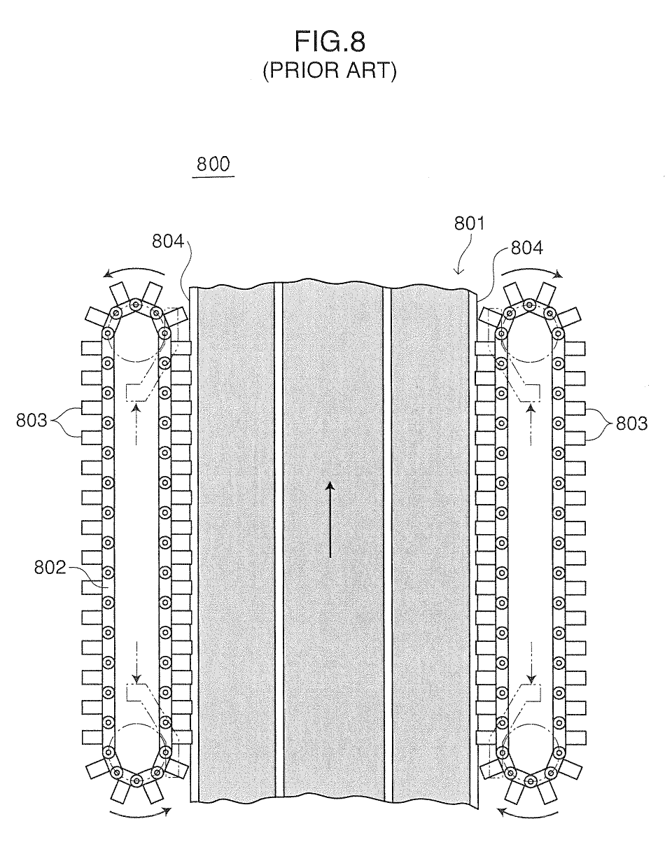

FIG. 5 is a schematic configuration diagram of an electrode dryer 300 according to Embodiment 3 seen from a side. A mounting member 9 is made of a metallic plate, for example. Preferably, the plate has a plane surface and a width equal to or larger than the width of the electrode base material 5 in a direction perpendicular to the conveyance direction of the electrode base material 5. Since the plane having a width equal to or larger than the width of the electrode base material 5 allows stable holding of the electrode base material 5, the electrode base material 5 is prevented from hanging down or swinging due to hot air during the drying and from having uneven coating as a result. The mounting member 9 may also have the above-described suction mechanism.

As described above, the electrode base material 5 coated with the electrode slurry 6 is dried while being held on a mounting member in a stable manner to be prevented from swinging due to hot air. It is therefore possible to reduce uneven coating due to hanging and wrinkles of the electrode base material 5, and obtain a highly even electrode.

The embodiments disclosed herein are illustrative of the present invention in all aspects and not to be construed as limiting the present invention. The scope of the present invention is defined not by the description above but by the appended claims and intended to embrace all alterations made within the scope of the invention defined by the appended claims and their equivalents.

The electrode dryer and the method for drying an electrode according to the present invention can be suitably applied to an apparatus for producing an electrode in the production of a lithium-ion battery or the like.

What is claimed is:

1. An electrode dryer comprising:
a drying furnace; and
a conveyance member for longitudinally conveying a band-like electrode base material coated with a coating material from an entrance to an exit of the drying furnace,
the drying furnace including an air-permeable mounting member for horizontally supporting the electrode base material to be conveyed in the drying furnace; and a suction member for sucking the electrode base material through the air-permeable mounting member.

2. The electrode dryer of claim 1, wherein the mounting member is equal to or larger than the electrode base material in width.

3. The electrode dryer of claim 1, wherein the mounting member has a plane surface for supporting the electrode base material.

4. The electrode dryer of claim 1, wherein the mounting member includes a plurality of rollers.

5. The electrode dryer of claim 1, wherein the mounting member includes an endless member traveling with conveyance of the electrode base material.

6. The electrode dryer of claim 1, wherein the suction member has a suction which is reduced or stopped in the vicinity of the exit of the drying furnace.

7. A method for drying an electrode, comprising the step of:
drying a band-like electrode base material coated with a coating material while longitudinally conveying the electrode base material from an entrance to an exit of a drying furnace,
the drying step including the steps of: mounting the electrode base material to be conveyed on an air-permeable mounting member; and sucking the electrode base material through the air-permeable mounting member.
